(19) United States
(12) Patent Application Publication
(10) Pub. No.: US 2011/0203996 A1
(43) Pub. Date: Aug. 25, 2011

(54) Process for the containment of oil spills

(76) Inventor: Carlos Felipe Forero Monsalve, Bogota (CO)

(21) Appl. No.: 12/660,185

(22) Filed: Feb. 22, 2010

(51) Int. Cl. C02F 1/40; C02F 1/28; B01D 53/06; B08B 7/00

(52) U.S. Cl. 210/691; 134/7; 95/141

(57) ABSTRACT

The inventive process involves the treatment of oil spills on a water or a solid surface. Once an oil spill has occurred, the oil spill is contained into a certain area. There after, the oil is sprinkled or spread upon with an adsorbent material which has a tendency to soak up the oil and maintain the same in its interstices created by a mass of particles. The particles do not allow the oil to integrate within its composition. Once the mass of oil and adsorbent material has been established, the mass may be recovered by removing the mass from the surface of the water or from a solid surface. Thereafter the mass is transported to a recovery system where the oil is removed or recovered from the mass by squeezing or pressing. The method also includes the step of collecting vapors that are generated by the spilled oil. There after, the adsorbent material may be used again in another oil spill after drying.

### BACKGROUND OF THE INVENTION

The invention relates to a process for the containment and decontamination of oil spills or leaks of oil in water, soil and other areas. The process involves both the adsorption and the absorption of oil contaminations.

Adsorption is the act of gathering a gas, liquid or dissolved substances on a surface in a condensed layer, as when charcoal adsorbs gases or oil floats on a surface.

Absorption is the act of sucking up or drinking up or a collection and retaining of liquid in a material through its molecular structure that causes the material to swell up to 50% or more. Absorption is at least 70% insoluble in excess fluid.

In processes currently used for collecting liquid substances less dense than water, such as oil, causing pollution of a body of water, as in the case of oil spills using mechanical devices that require complex and expensive processes.

Absorbent products and materials currently on the market consists of vegetable, synthetic and absorbents such as such as: wood chips or saw dust, minerals: such as, talc, mica or fiberglass, coal products, graphite, charcoal or coke, plastic products: such as, polyethylene or PVC, rubber and products made from industrial waste, cellulose, cotton and nylon, which can perform the same function of ADSORBENT NOW, but with less absorptive capacity and an inability to on aqueous surfaces (water), thereby not retrieving the oil and generating high costs during final disposition. Products made of saw dust, peat and sand have the disadvantage of being very bulky, causing problems during handling and transporting. They are also slow to absorb the oil once contact is being made and large amounts because of their slow absorptive capacity, and are not applicable in water and create problems after being used because they become hazardous waste.

There are other types of products that can serve as complements to the function of absorbing, such as, degreasers, detergents, cleaners, etc. The advantage of biodegradability is only present in the product and not in the hydrocarbon with which the pollution is transferred to some other place. This action does not occur with ADSORBENT NOW, as the largest possible amount of the contaminant is captured from the soil and water, virtually 100% in water, as will be explained below.

With regard to plastic barriers and concrete containment dikes, in addition to being extremely expensive, they only prevent the effusion but do not absorb the oil, which can create emergencies and environmental damage.

In cases of accidental oil spills caused by a vehicle crash, that usually leaves a stain of oil on the roadway, as well as not taken into account the equipment or processes to remove bunker fuel, there exist a concern of causing another accident. To date, the management of theses accidents has been using different absorbents that integrate the oil into its composition.

With regard to the current use of primarily cardboard and paper, this type of material absorbs very little of the contaminant and once contaminated creates a greater environmental hazard. Utilization of these otherwise recyclable products defeats their normal advantageous properties.

Degreasers and cleaners do not perform the same function. What they really do is move the oil and addition to not being biodegradable further contribute to water pollution. It degrades the soap and not the oil.

### BRIEF DESCRIPTION OF THE INVENTION

Currently, throughout industry, no technology exists (i.e. there is no known product or process), in which the application involves a truly biodegradable adsorbent product obtained from municipal solid waste as recycled fiber (consisting of paper, textile and vegetable waste) with the capability of collecting a liquid substance less dense than water as well as encapsulating the vapors caused by spills or leaks of hydrocarbons in soil or water or on solid surfaces. Such substances may be spilled oil and petroleum, oils, solvents etc. including vegetable oils. The inventive process can recover the pollutants, utilizing a clean and safe process and equipment, from both bodies of water and from land (of varying densities) or other solid surfaces, therefore, significantly decreasing the environmental impact of oil spills.

The inventive process can easily be applied to an emergency spill manually or mechanically (with blowers or sprinklers). The adsorbent material draws to its surface both liquids and gases, but the molecules of theses materials do not penetrate the body or the substance of the product particles, as is the case with absorbent products in which the molecules of the liquid or gas pollutants are retained within the absorbent products, creating a difficulty regarding the later separation process that is necessary for the petrochemical product's reuse.

The inventive product is lightweight and easy to carry. It's capacity for adsorption requires smaller volumes; adsorption is rapid, it can be used in water, and once used can easily be collected and processed, thereby not becoming contaminated waste. Yet, another benefit of it's use is derived from the fractional amount of the product that remains after the petrochemicals have been recovered being further utilized (by constituting other products such as building materials).

### BRIEF DESCRIPTION OF THE DRAWINGS

FIG. 1 illustrates a floating tube kept floating by empty bottles,

FIG. 2 is the tube of FIG. 1 kept floating by inflation;

FIG. 3 is the tube of FIG. 2 kept floating by styrofoam particles;

FIG. 4 shows a tube for moving contaminants from a solid surface;

FIG. 5 is a cross section through the tube of FIG. 4.

### DETAILED DESCRIPTION OF THE INVENTION

Basically, the starting point of the invention involves recycling, the process by which harnessed and transformed solid waste is recovered and returned to its potential reinstatement materials as the feedstock to manufacture new products. Recycling may consist of several stages: processes of clean technology, industrial conversion, separation, selective collection, storage, reuse, processing and marketing.

The process for obtaining the inventive adsorbent substance used to pick liquid and gases that are less dense than water are as follows:

As a first stage, there is a selection of raw materials from solid wastes such as paper products, cardboard, used clothing, textile waste, fibrous plant residues, wood, banana stems and leaves, fruit peels and other derivatives of fibrous agricultural products.

In a second stage the raw material is divided into sub-groups according to their origin as follows: Derivatives of paper, such as, newspaper, cardboard, folding, carbon paper.

Derivatives of products, such as, plastic combined with aluminum. Adhesives, packaging of milk products.

Derivatives of textiles, such as, cotton, linen, worn clothing and excess cutoffs in the clothing industry.

Derivatives of agricultural products, such as, sugar, cane stalks, fruit pods, crop waste, cotton, barley, coconut, cassaya etc. this step proceeds to performing cutting grinding shredding and chopping, and these steps are performed simultaneously for each of the subdivisions of raw materials.

In a third stage the selected material is passed by conveyor belt where the verification process is performed to be sure that no foreign substances are included, as well as confirming that any different material (other than required to advance to the next step) is excluded.

In a fourth stage the three distinct sources of waste materials are separately processed. All of them are ground to 3-5 cm square in size. The operation is performed by machinery for the type of material as follows:

1. Cutting of waste paper products to approximately 3 cm wide strips, taking special care to remove hooks, staples, tapes, adhesives plastics, cold pack plastic and any other foreign elements. Grinding is performed on papers combined combined with materials such as plastic, aluminum, foil, adhesives, carbon paper and the materials are reduces in size to 6-6 mm and then separated in an impact mill.
2. A shredding machine reduces textile waste products after having been hand selected and stripped of foreign objects such as buttons, snaps, clips, zippers etc. Sanforized fabrics and elastics are also separated for exclusion.
3. Chopping of agricultural culls, having previously been dried and categorized, reduces their dimension to 6 mm.

A fifth stage involves the maturation that takes place in a closed tank, which is comprised of: 1. Pulping, where the shredded dry material is irrigated by adding enough water and selected chemical liquor or sodium hydroxide, sodium carbonate, at a temperature of up to 235 degrees centigrade. 2. The resulting batter is continuously agitated as it is mixed, imparting to the product an added potential for attraction imparted by the action of the chemical additives that facilitate the removal of substances which adversely the efficiency of the adsorbent (such as starches, sugars, gums, and links as well as contaminants that may have been introduced inadvertently during previous stages). All these undesired elements are then removed by successive washes. 3. The thoroughly washed fibers are then treated with sodium silicate to reach a neutral pH (if necessary) and 10% humidity

Depending on then type of material maturation is performed in accordance with the following conditions and parameters;
For textiles: 35 Kg/L water, 5% chemical liquor, temperature at 85 degrees C., pH=8, internal pressure of 2.1 Kg/cm2 system and a time of 60 minutes.
For paper 20 Kg/L water, 3% of chemical liquor, temperature at 60 degrees C., a pH=6, internal pressure of 1.8 Kg/cm2 system and a time of 60 minutes
For plant materials 25 Kg/L water, 20% chemical liquor, temperature 135 degrees C., pH=9, internal pressure of 2.9 Kg/cm2 system and a time of 480 minutes.

Sixth stage. Dry the material from the previous stage, with hot air circulation at temperatures between 180 and 230 degrees C. for approximately 120 minutes. Then the dried material is removed from the machine and allowed to stand at room temperature for 60 minutes.
The invention of this application provides a process for containment and clean-up of oils spills or leaks in water, soil and other contaminated surfaces, through adsorption of vapors, liquids and hydrocarbons generated along the chain of oil and other fuels and lubricants plant origin.

This collection, management and disposal apply the principles of cleaner technology to use solid waste as raw materials recycled as fibrous papers, textiles and vegetables. In addition there is no additional waste generated in these processes.

The components are treated separately, then mixed and processed to a pulp. This pulp is packing in different presentation to safely collect vapors and oily liquids in nature with a density less than water, such as petroleum and petroleum products, vegetable oils and other substances.

The impregnated adsorbent is cleaned by mechanical processes to remove residual hydrocarbons and water suitable for pouring.

Seventh stage. The blending of the final moisture free product occurs where equal parts from paper pulp, textiles and vegetables are mixed together and then passed on to the carder machine first by a diameter of 4 mm and then by one of 2 mm, which also combs the fibers, increases the bulk/volume. The finished inventive product is released for vacuum packaging and storage in in isolated areas free of moisture.

The inventive product produced according to the process described above is lightweight, compressible, odorless, tasteless, biodegradable, leaving no residue clas, with an adsorption of 1:20 times its weight and is easily retrievable due to being non-reactive with products with which it contacts.

Being made of organic materials, the product is biodegradable, and has a rapid decomposition rate, and therefore is not at all harmful to the environment.
Among many other industrial applications, the adsorbent product obtained:
   1. Adsorbs and recovers efficiently and quickly in soil and water which is polluted by hydrocarbon spills, including those encountered during maintenance or normal operations.
   2. Avoids, controls and reduces the pollution caused by hydrocarbons.
   3. Cleans hydrocarbon efficiently.
   4. Rescues nonrenewable resources; the current practice of remediation which involves adding bacteria to consume the oil at the spill site excludes the possibility of collecting the oil mechanically and then recovering up to 80% without altering it's composition (not that of the renewable/reusable alternative).
   5. Augments the cleaning of production plants and storage facilities, reducing safety hazards and risks which also improves productivity.
   6. It is nonabrasive, consequently it's use in the cleaning of machinery produces no wear at all.
   7. Diminishes the like hood of fires and other accidents resulting oil spills, by encapsulating the oil between the product and the water surface 9 (applied with a source such as a hose if water is not already present) thereby not allowing the gases (which are explosion producing) to escape.
   8. Assists and allows organizations, businesses, industries, and government bodies to meet current environmental standards.
   9. Improves the effectiveness/valuation of companies involved in occupational health and environmental management.
   10. Dismisses the general volume of waste.

Another advantage of the product is the realized once a large volume of the adsorbent material has been used, it can given a final provision which can be dine by incineration, bio-remediation and/or processes for obtaining pulps. One important reason is the fact that hydrocarbons are being depleted (removed from the product) and therefore, the treatment given may be more environmental, and so saving nonrenewable resources, as well as incurring lower costs associated with handling and processing smaller volumes of waste (handling fewer hydrocarbons), which was achieved through the product development process together with the proper handling of the product after use.

### The Following Steps Must be Performed

Store the adsorbent material in a plastic container without any waste (paper, cigarette butts, etc.) and indoors only.

Take samples of the impregnated adsorbent, in order to evaluate the psycho-chemical composition, levels of acidity or alkalinity, moisture, temperature, amount of oil, amount of organic material. Cause drip-stage separation of oil and/or fuel, adsorbent and collected sand for which a centrifuge is used, where the saturate adsorbent with oils placed. In two (2) minutes elapsed time the oil and adsorbent material separates. The hydrocarbon obtained can be used since it's composition has not been altered.

Once drained, the adsorbent material is subjected to a wet separation process with a stirring system, which basically occurs in two cycles, that is, an engine and a driver in which water is added along with a flocculate product (varsol). Once the mass is homogenized, it goes to rest in a tank where chemical coagulants are introduced. Suspended solids are removed by gravity; depending on the natural tendencies the solid particles are deposited on the bottom or rise during calm condition. The particles having a specific gravity higher than the liquid phase settles and those with a lower specific gravity float.

Once the raw material thus obtained has been accumulated, it will be transported to industry to make new products, such as:

Pulps: adsorbent fibers are converted into pulp for the manufacture of agglomerated, packaging, cartons, etc.
Energy source: When the material consisting of a blend of the adsorbent material with the contaminated material yields a 30% saturated hydrocarbon, that material can become raw material and energy source in the form of briquettes. The burning of the briquettes can be provide up to 700 degrees F. while producing minimal amounts of smoke and ash.
Plastic objects: The adsorbent is impregnated and used as a fill material for the manufacture of objects that mimic wood, concrete and pavement (building materials.
Composting substances: (bio remediation): Once drained, the adsorbent material may be subjected to composting processes, formulated by stirring the adsorbent material together with plant debris, soil, and fungi, thereby gaining a beneficial material capable of hastening the recovery of vegetation cover pour in soil. The water used must be filtered taking into account the waste, sludge and sediment created in the manufacturing recovery and treatment. The filtered water can then be introduced into streams and/or public sewers.

Studies were conducted to evaluate and improve the performance of the industrial adsorbent material made from recycled cellulose (that is the adsorbent material) when used to collect oil suspended in water by using experimental design and methodologies. To conduct an evaluation of the product it is must be considered that the most important performance conditions with which an adsorbent material must comply when used to remove oils suspended in water are:

1. The ability to recover oil at a high level of capacity with a homogeneous effect on different types of oils.
2. A high level capacity for oil recovery after collection.
3. An inability to alter the properties of the fluid being collected.
4. A high rate of reuse.
5. An extended float time. (some products lose buoyancy as they absorb oil.
6 . . . . Low levels of water absorptions.

The aim of the evaluation of the industrial adsorbent material is to determine which process parameters are crucial regarding the performance of the adsorbent material when used to recover oil suspended in water and to determine the levels at which theses parameters ensure optimum product performance with minimal variability.

After having made the respective evaluations, the evidence verified was that it was discovered that the adsorbent product's performance is enhanced mainly by the fiber's size and the space between them, and therefore, the factors of the production process that must be taken into account are those that effect these properties and as such it has been determined that the following parameters are controllable factors of the process.

### Reception of Raw Materials

### Pulping Process

Reactive type: Results can be obtained by using soda ash, caustic soda or calcium, hydroxide, and the type of reagent determines the reaction's intensity and, therefore, determines the resultant levels of the final product's properties, however the first two mentioned above are highly caustic pollutants, thus calcium hydroxide is preferred and the intensity level of the reaction is controlled by the other factors in the cooking process.
Concentration of reagent: The alkalinity of the liquor determines the level of the hydrogen bond breaking activity, which is directly related to the size of the fiber. The pH of the water used in the process affects the reaction and thereby the final characteristics of the fiber, however the pH of the cooking liquor is controlled by the concentration of the reagent.

### Carding Process

The weather determines the space between fibers, which is crucial to complete the action.

The process essential as:

1—Front of materials.

### 2—Crushing:

Cut
Ground
Defibrillation
Chopped

### 3—Maturation

Pulping
Smoothing
Refining

### 4—Drying

### 5—Card

### 6—Pack

### 7—Storage

It is important to note that various events can result in either a small medium or large volume of waste being generated, and that all personnel who encounter any amount of waste (either in liquor solid forms) are handling hazardous materials, the need therefore arises to develop a process that first takes into account site logistics, and then the collection, the storage and disposal of the waste, which will then best protect human health and the environment from the hazardous material.

Therefore, conditions should be controlled at the source, using the proper level of technology to suit each need. It is desirable to set up a temporary collection center in each company, where the waste is disabled and classified (as sewage, water and waste) for storage and future delivery to a company specializing in and processing and utilizing all the infrastructure and specific products and devices required to achieve the goal.

Process for Decontamination by Adsorption of The Hazardous Vapors and Liquids (of Hydrocarbons) Generated in the Presence of Water and Soil (by Spills, Handling Practices and Disposal Techniques) while Deploying Cleaner Technologies.

Once the oil is spread on any surface, evaporation should be avoided by encapsulating the spill with the inventive adsorbent material, which is applied using a sprayer or by a manual operation. The fuel adheres to the adsorbent material immediately upon contact with water, and the adsorbent material or product smothers the evaporation and prevents the progress of the spill. If the spill is happening on the surface of a body of water, the spill should first be contained from spreading by using a floating tube.

FIG. 1 illustrates such a tube 1. Its structure is made up of an elongated hollow floating tube F which is kept floating by inserting a certain number empty plastic bottles 1 having the spout closed. This way, when any of the floating bottles 1 is damaged, the remaining empty bottles keep the floating tube in a floating state At the bottom of the floating tube F there is provided a sheet of open mesh material 2. The reason for the presence of this screen is to prevent the floating tube F from turning as the tube is moved across the water, as will further be explained below.

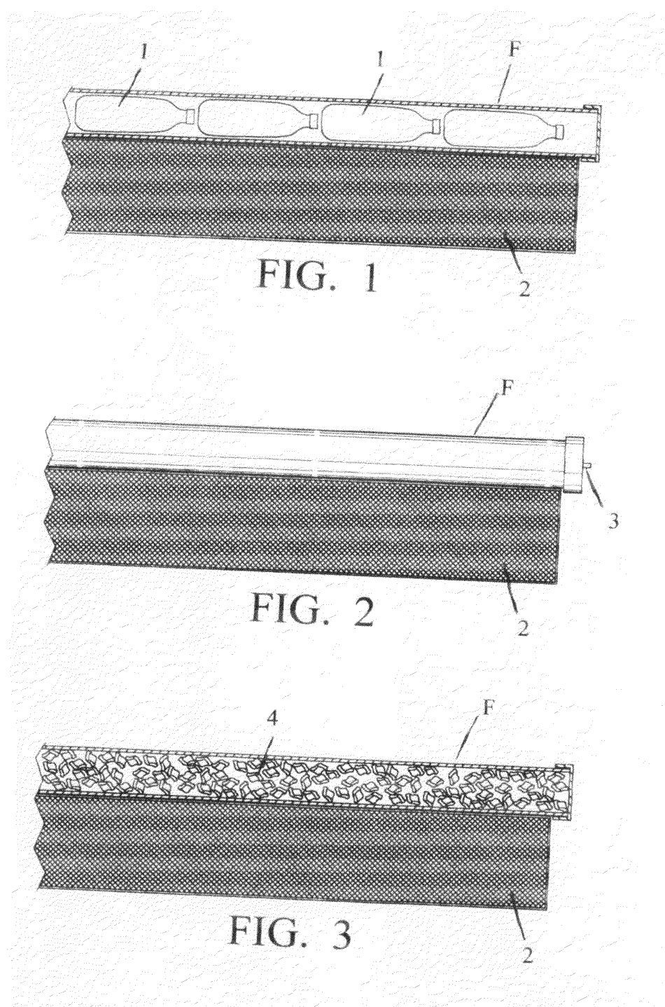

FIG. 2 embodies the same principle as was explained with regard to FIG. 1. Again this FIG. 2 shows the floating tube F but is kept in a floating state by adding compressed air into the tube by way of the valve 3.

FIG. 3 again is the same principle as was explained with reference to both FIGS. 1 and 2. The tube F in this embodiment is kept in a floating state by being filled with styrofoam particles. Theses particles are various porous and, therefore, contain a great amony of air that will the tube F in a floating state, even if it is damaged.

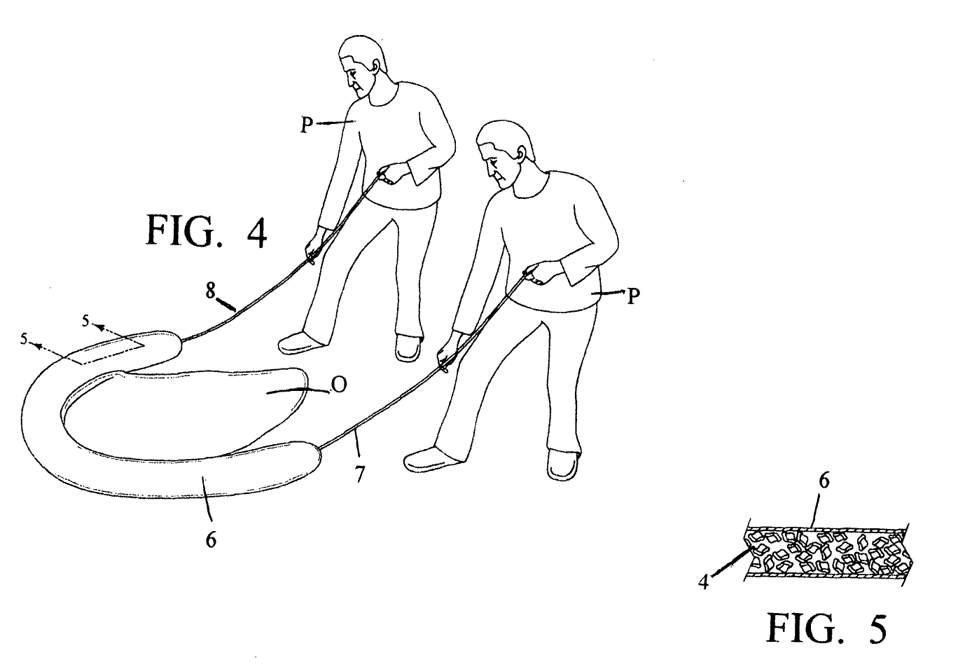

FIG. 4 is a different embodiment for use to contain an oils spill O on a substantial rigid surface. The elongated plastic tube 6 has a string at each end shown as 7 and 8. To give this tube some weight it could be filled with styrofoam particles shown as 4 in FIG. 5 which is a cross section through the tube 6. To increase the weight and, thereby, the effectiveness of the tube 6 some amount of sand could be added to the tube 6 as the conditions of oil spill dictate. The strings 7 and 8 are each handled by one person or by two persons P1 and P2. This will be depending on the size of the oil spill that is being treated.

The soil vapor extraction or surface water is adequate for the elimination of a variety of pollutants that have a higher evaporation rate than that of water, such as a light hydrocarbon (gasoline, ethanol, thinners, and solvents such as varsol among others). The solid vapor extraction or surface water is characterized by a rapid remediation technique. This all controlled by the effective and proper use of the adsorbent material or product as it encapsulates the spill and thereby prevents evaporation and dispersion of the hydrocarbons.

### OPERATION

When an spill occurs on a body of water, it is important that the containment tube as shown in FIGS. 1-3 are employed to contain the oil in a certain area and to prevent any further spreading. After that the adsorbent material should applied, sprinkled or spread throughout the are of the oil spill. As a consequence the adsorbent material will suck up the oil from the water and secure it in the interstices that are present in the adsorbent material. As was previously discusses above, the interstices are created by the existence of fibers or other particles. Unlike absorbent materials having been used that will absorb the oil within the absorbent particles, the adsorbent particles do not contaminate the particles. Once the oil and the adsorbent material are treated or combined into mass, they can be recovered or stripped from the water by way of various technologies. Once the oil and adsorbent material combination mass is recovered, the oil located within the mass can also be recovered be squeezing or compression methods whereby the oil is freed from the interstices of the adsorbent material. After this method, the adsorbent material can be used again in a different location.

When an oil spill occurs on a solid surface such as on asphalt or concrete, the recovery tube of FIGS. 4 and 5 can be used. The adsorbent material or product is spread on the oil spill, again resulting in that oil is retained in the interstices of the adsorbent material. As can be seen from FIG. 4 one or two persons, depending on the size of the spill will drag the tube 6 by the end strings 7 and 8 across the spill and convey the spill to a recovery area. In this area certain technology will pick up the mass consisting of the adsorbent material and the oil contained therein to a treatment area where the oil may be pressed or squeezed out of the mass and may be recovered. This recovery is not known to done by any other recovery methods to date.

What I claim is:

1. A method of recovering an oil spill from a surface of water or a solid surface comprising the steps of spreading adsorbent material on said oil spill, said adsorbent material having interstices within its collection of incoherent particles, allowing said oil to penetrate to within said interstices and collected thereby to form a mass.

2. The method of claim 1 wherein said adsorbent material is selected from the group of adsorbent raw materials consisting of paper products, cardboard, used clothing, textile waste, fibrous plant residues, wood, banana stems and leaves or fruit peels.

3. The method of claim 1, including the step of containing said oil spill into a certain area.

4. The method of claim 3, wherein said tube has a mesh screen depending there from to keep the tube from turning on itself when dragged across a body of water.

5. The method of claim 1 including the step of recovering said mass from the spilled area.

6. The method of claim 5 including the further step of recovering said oil from said mass once it is recovered from said spilled area.

7. The method of claim 6 wherein said step of recovering said oil from said mass includes the step of pressing or squeezing said recovered mass to expel said oil there from.

8. The method of claim 1 wherein said oil spill is contained on said solid surface by a weighted tube by dragging said tube across said solid surface.

9. The method of claim 8, including a further step of spreading an adsorbent material on said oil spill, allowing said oil to penetrate to within interstices of said adsorbent material.

10. The method of claim including the step of collecting vapors in said adsorbent material, said vapors are generated by said oil having been spilled.
